(19) United States
(12) Patent Application Publication
(10) Pub. No.: US 2011/0101844 A1
(43) Pub. Date: May 5, 2011

(54) SPARK PLUG HAVING PRESSURE SENSOR

(75) Inventors: Josef Glaser, Graz (AT); Gernot Leuprecht, St. Radegund Bei Graz (AT)

(73) Assignee: KISTLER HOLDING AG, WINTERTHUR (CH)

(21) Appl. No.: 13/001,873

(22) PCT Filed: Jul. 2, 2009
(86) PCT No.: PCT/CH09/00230

§ 371 Date: Dec. 29, 2010

(30) Foreign Application Priority Data
Jul. 2, 2008 (CH) CH 1035/08

(51) Int. Cl. H01T 13/20; G01M 15/08

(52) U.S. Cl. 313/141; 73/114.19

(57) ABSTRACT

A spark plug is intended for combustion engines and comprises a metal housing having a ground electrode disposed at the front and a thread having a rear sealing surface for installation in the combustion engine. The spark plug in particular includes a pressure sensor disposed laterally in the housing for determining a combustion chamber pressure and a ceramic body having a center electrode. The ceramic body is disposed in the housing next to the pressure sensor and acting as an electric insulator. As viewed from the combustion chamber, the ceramic body defines a front clamping shoulder and a rear stop for clamping the ceramic body into the housing. The outside diameter of the ceramic body gradually decreases in the region of the thread located between the rear sealing surface and the front clamping shoulder.

### CROSS-REFERENCE TO RELATED APPLICATIONS

This application claims priority to International Application Serial No. PCT/CH2009/000230 filed Jul. 2, 2009, which claims priority to Swiss Application No. CH 1035/08 filed Jul. 2, 2008.

### TECHNICAL FIELD

The invention relates to a spark plug, the basic design of which is intended for internal combustion engines, comprising a metallic housing with an earth electrode arranged at the front and a thread with a rear sealing face for installation in the internal combustion engine, a pressure sensor arranged laterally in the housing for determining a combustion chamber pressure, a ceramic body with a central electrode, which sensor is arranged next to the pressure sensor in the housing and acts as an electrical insulator, wherein the ceramic body, as viewed from the combustion chamber, has front clamping shoulders and a rear stop for clamping the ceramic body in the housing.

### BACKGROUND

Spark plugs of this type are already known. To accommodate the pressure sensor next to the ceramic body in the housing, the ceramic body has a reduced outer diameter in the front region of the thread. This has the disadvantage that the point of tapering is a very weak point in the ceramic body, which is exposed to a high risk of breakage on mechanical loading. The wall thickness of the ceramic body is also reduced by the reduced outer diameter, which results in a high risk of breakdown on electrical loading by ignition voltage. Such spark plugs are insufficient for use.

The problems arise from the interaction of different circumstances:

As the sensor must be accommodated next to the ceramic body, but the thread size is predefined, the ceramic body must be smaller in this region and also shift out of the centre to the side. A shift of the axis of the ceramic body is disadvantageous owing to the changed ignition conditions in the combustion chamber. Therefore, the nearer the ceramic body comes to the centre, the thinner it needs to be in the said front region.

The ceramic body is additionally exposed to high mechanical stresses during installation in the engine and during use. For example, a lateral force during the rear connection of the spark plug, caused by the application of force by a mechanic or by severe vibrations during use, can cause a breakage of the ceramic body in the region of the thread between the rear sealing face as far as the front clamping shoulder. This region is particularly at risk, because it must be thin in the thread region and is clamped between the clamping shoulder and the stop.

FIG. 1 shows, in a schematic sectional illustration, a spark plug 1 for internal combustion engines according to the prior art. The combustion chamber 19 is on the right of the picture. The spark plug 1 comprises a metallic housing 2 with earth electrodes 3 arranged on the front, aligned towards the combustion chamber 19. A pressure sensor 4 for determining a combustion chamber pressure is arranged laterally in the housing 2 and has a sensor connector 5. Other designs in which a connector is not integrated are also known. These generally have the disadvantage that a sensor cable projects out of the spark plug. This must not be damaged when the spark plug is installed. The disadvantage is that the cable cannot be replaced separately.

Next to the pressure sensor 4, likewise arranged in the housing 2, there is a ceramic body 6 which acts as an electrical insulator for a central electrode 7 which runs centrally through this ceramic body 6. The ceramic body 6 has, viewed from the combustion chamber, a front clamping shoulder 8 and a rear stop 9. These are used to clamp the ceramic body 6 in the housing 2 by means of a screw element 10.

In the front region of the ceramic body 6, in front of the clamping shoulder 8, the ceramic body 6 decreases generally in a conical or similar manner. This region defines the thermal value of the spark plug and is without significance for the present invention. A thread 21 is also applied to the housing, with a sealing face 18 towards the engine.

An abrupt step 20 is applied in the region between the front clamping shoulder 8 and the rear stop 9 at a point near the rear stop 9, as a result of which the ceramic body 6 has a smaller space requirement in the front region. The ceramic body 6 with an axis 14 of the central electrode 7 can thus be arranged in the housing 2 shifted away from an axis 15 of the spark plug 1 by a distance A. This creates additional space on one side in the housing 2, in which the pressure sensor 4 can be accommodated.

A disadvantage of such a spark plug 1 according to FIG. 1 is the thinness of the ceramic in the part of the ceramic body 6 between the front clamping shoulder 8 and the step 20, and the associated susceptibility to breakage of the ceramic body on tangential application of force in the region of the connection 17, as a consequence of the reduced outer diameter D_{K}, because the pressure sensor 4 and/or the contact necessary for it must have space as well. The thinness also increases the risk of breakdown. The risk of breakage is particularly increased if the ceramic body projects out of the housing at the rear.

A great disadvantage of such a spark plug 1 according to FIG. 1 is the high risk of breakage at the step 20. This point is exposed to high stress during severe vibrations. Even a small hairline crack greatly increases the risk of breakdown at this point.

In addition, the distance A has the effect that the ignition does not take place in the combustion chamber 19 at the point at which ignition takes place in a spark plug which has no pressure sensor 4. This spark plug 1 according to FIG. 1 is thus not appropriate for any normal situation.

### OBJECT AND SUMMARY OF THE INVENTION

The object of the present invention is to specify a spark plug of the above-described type with regard to its basic design, which has increased mechanical strength, while at the same time shifting the ceramic body in the direction of the central axis of the housing.

The object is achieved as described below.

The idea on which the invention is based consists in that the outer diameter of the ceramic body decreases gradually in the region of the thread between the rear sealing face of the housing as far as the front clamping shoulder of the ceramic body. The fact the ceramic body does not run in a cylindrical manner in this region like other ceramic bodies from the prior art means that valuable space is freed up in the front region for arranging the sensor.

Because the diameter in this region does not decrease abruptly but continuously over this region, bending strength is increased and the risk of the ceramic body breaking is greatly reduced. The structurally induced potential breakage point of the prior art owing to the abruptly reduced wall thickness of the ceramic body behind the stop is in particular eliminated.

In addition, the greater outer diameter of the ceramic body which is achieved in this manner means that the wall thickness of the latter is increased towards the rear, which has a direct effect on greater breakdown resistance. The insulation thickness of the ceramic body at each point can be optimised to the structural conditions by the essentially continuous reduction in the outer diameter. This means that a central cutout for an interference suppression resistor can be arranged in the rear region, it being possible to retain the necessary wall thickness of the ceramic body for the breakdown resistance.

Further preferred embodiments are described in the subclaims.

### BRIEF DESCRIPTION OF THE DRAWINGS

The invention is explained in more detail below with reference to the drawings. The reference symbols have the same meaning for all the drawings. In the figures:

FIG. 1 shows a schematic sectional illustration of a spark plug according to the prior art;

FIG. 2 shows a schematic sectional illustration of a spark plug according to the invention;

FIG. 3 shows various outer contours according to the invention between the front clamping shoulder and the rear stop.

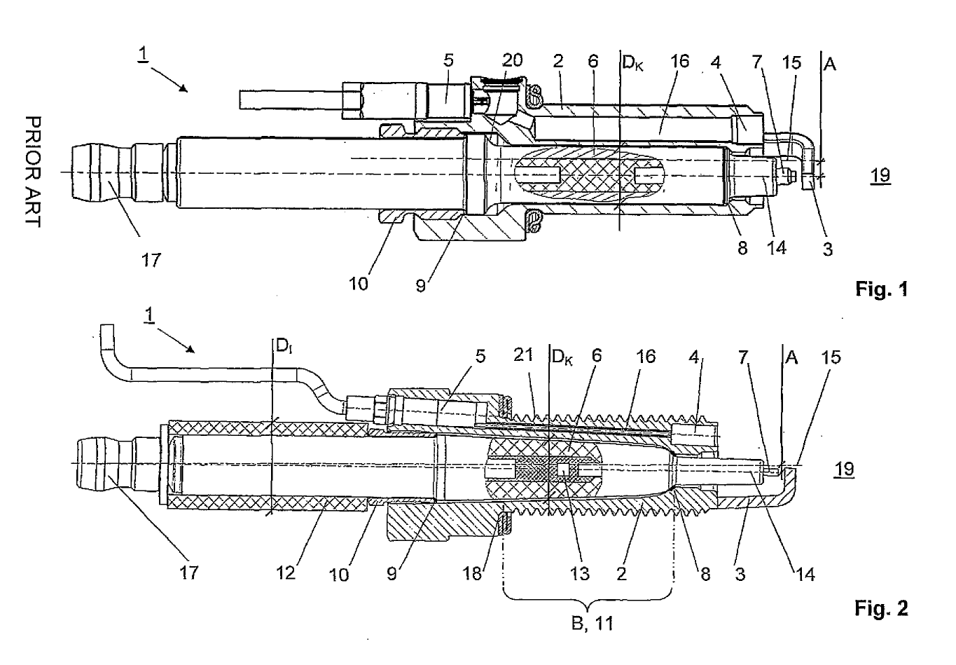

### DETAILED DESCRIPTION OF EXEMPLARY EMBODIMENTS

FIG. 2 shows a schematic sectional illustration of a spark plug 1 according to the invention. It likewise comprises a housing 2 with a thread 21 and a sealing face towards the engine 18, an earth electrode 3 at the front and, arranged next to the latter, a pressure sensor 4 with a sensor connector 5 and a ceramic body 6 with a central electrode 7. The ceramic body 6 in turn has a front clamping shoulder 8 and a rear stop 9, by means of which the ceramic body 6 can be clamped in the housing 2 with the aid of a screw connection 10. As an alternative, it is also possible for a sensor connector 5 to be attached to the housing 2, in which case only a cable guide leads out of the housing 2.

In preferred embodiments the sensor is installed in the front region of the spark plug, preferably frontally on the combustion chamber side. This is a structural necessity particularly if the thread is an M14 thread or smaller.

In contrast to the prior art, the outer diameter D_{K} of the ceramic body 6 decreases spread over a large region 11 in this embodiment according to the invention.

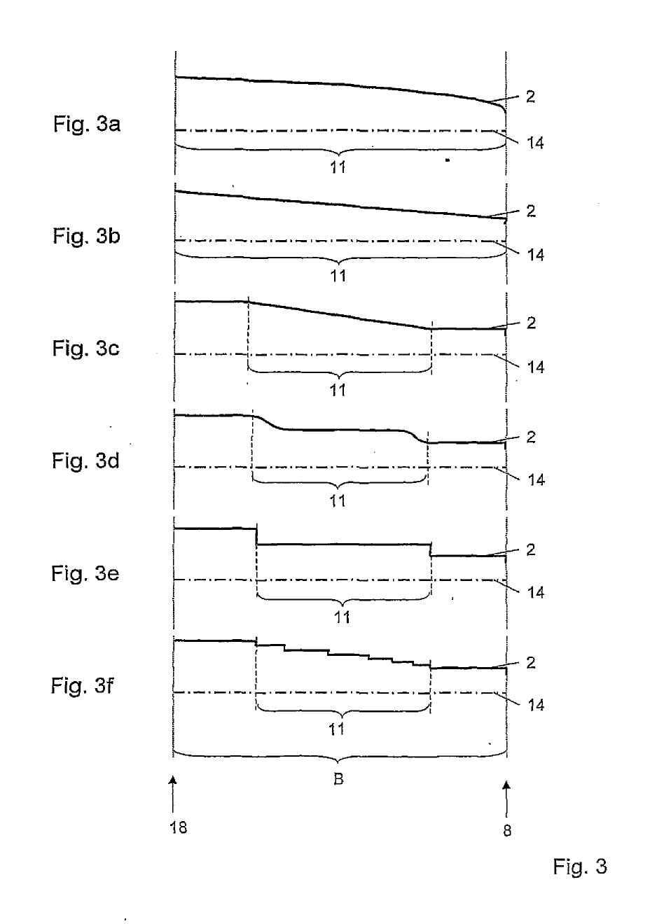

FIG. 3 shows different outer contours of a ceramic body according to the invention in the region B. In FIG. 3a the outer contour in the entire region B is parabolic, in which case the decreasing region 11 makes up the whole region B. This outer contour results in the best bending strength of the ceramic body 6. FIG. 2 likewise shows such a parabolic outer contour.

A conical outer contour is shown in FIGS. 3b and 3c, the decreasing region 11 in FIG. 3b making up the whole region B, but in 3c only approximately half of the region B. In FIGS. 3d, 3e and 3f the decreasing region 11 likewise comprises only approximately half of the region B, the decrease in this case running in two stages (FIG. 3d, e) or in a plurality of stages (FIG. 30, between which the outer contour can have a cylindrical profile. The stages can begin and/or end in an angled or rounded manner and they can run conically as in FIG. 3d or perpendicularly to the axis 14 as in FIG. 3e. Combinations of the said features are also possible. The decisive feature for an outer contour according to the invention is however that the whole decreasing region 11, which is defined as the region between the first and the last decreases within the region B, irrespective of central cylindrical regions and excepting the clamping shoulder 8 and the rear stop 9 itself, makes up at least 50% of the region B. The region 11 should preferably make up at least 70-90% of the region B.

Whether the best strength is achieved by a conical or parabolic outer contour, the suboptimal solutions are depending on the design only slightly poorer and also assume the idea of the invention, according to which a gradual reduction in the diameter from the rear in the region of the thread towards the front clamping shoulder 8 maximises the breakage resistance with optimised space requirement for a sensor and as little deviation of the ceramic body from the centre as possible. Ideally, the outer diameter runs uniformly gradually as far as the rear stop 9.

The embodiment according to the invention prevents a situation in which the entire reduction in diameter takes place in a very small region as in the prior art, where only a single step of the outer diameter D_{K} is present, which firstly reduces the strength of the ceramic body and secondly increases the risk of breakdown at high voltages.

The spark plug 1 shown in FIG. 2 also comprises, apart from the said basic design, an insulation sleeve 12. This surrounds the ceramic body 6 in the rear region as far as a connection 17. The basic design can be fitted with such an insulation sleeve 12 with a selectable outer diameter D_{I}. The same basic design can thereby be simply adapted for different connections 17, as different manufacturers of spark plugs demand different outer diameters D_{I} of the insulation sleeve 12 for the connections 17. The spark plug caps placed on the spark plugs 1 must enclose the insulation sleeves 12 well with their rubber lips so that breakdown is prevented. The spark plug 1 according to the invention can thus be supplied with ignition voltages of more than 30 kV without a breakdown being likely.

An interference suppression resistor 13 can also be installed in the ceramic body 6, which resistor can be accommodated only inconveniently in a conventional arrangement according to the prior art. The space in the interior of the ceramic body 6 is created by the slow reduction in the outer diameter D_{K} of the ceramic body 6 in the said region 11, no losses of insulation having to be accepted. The space in the interior of the ceramic body 6 can preferably be created at its thickest point so that the minimum wall thickness, which is decisive for the breakdown resistance, is maximal.

The configuration according to the invention of the ceramic body 6 means that the ceramic body 6 can generally be shifted so far into the centre of the spark plug 1 that the axis 14 of the central electrode 7 is no more than 1 mm away from the axis 15 of the spark plug 1. An ignition with the spark plug 1 according to the invention with a pressure sensor 4 can thereby take place very close to the point at which ignition would normally take place with a spark plug without a pressure sensor.

The sensor connector 5 is a particular challenge for accommodation in the housing 2. Spark plugs with pressure sensors but without sensor connectors are also known. In these models a sensor cable runs from the pressure sensor directly out of the housing and is connected externally to an evaluation device. These models have fewer problems as they do not have to accommodate any connectors. The disadvantage of this arrangement is that in this case the sensor cable cannot be replaced. The configuration of a spark plug 1 according to the invention can in particular be with or without a sensor connector 5.

A further challenge is the type of pressure sensor. In principle optical and piezoelectric pressure sensors can in particular be used. Optical pressure sensors are smaller and therefore simpler to accommodate in a spark plug. On the other hand, they easily get dirty owing to soot deposits and are less well studied in terms of their functionality. Piezoelectric pressure sensors are larger and therefore more difficult to accommodate, but very well known with respect to their behaviour.

It is advantageous if the insulation body is attached replaceably in the housing, because the sensor generally has a longer service life than the spark plug. The sensor can then be reused.

A contact 16 runs between the pressure sensor 4 and the sensor connector 5, if installed, by means of which contact the data acquired can be transmitted. The contact 16 preferably comprises only one measurement line, whereas the earth line runs via the metallic housing 2. The measurement line must however be highly insulated. A conventional contact with two measurement lines is also possible. The contact 16 is according to the invention connected eccentrically to the sensor connector 5. Space can again be saved thereby, as the sensor connector 5 can be accommodated behind a housing step 18 where the housing has a greater outer diameter than in front of this housing step 18. The sensor connector 5 can be attached further outwards on the housing 2 due to an eccentric attachment of the contact 16 to the sensor connector 5. The ceramic body 6 can thereby in turn have a greater outer diameter D_{K} at this point. The eccentric attachment to the sensor connector 5 is also advantageous because in this manner an essentially straight contact can be realised without a projection having to be present in the contact 16. This connection can have a rigid design and preferably be pluggable. Advantages of such a contact are for example its high resonance frequency.

### LIST OF REFERENCE SYMBOLS

1 Spark plug
2 Housing
3 Earth electrode
4 Pressure sensor
5 Sensor connector
6 Ceramic body
7 Central electrode
8 Clamping shoulder
9 Stop
10 Screw element
11 Region in which the outer contour decreases
12 Insulation sleeve
13 Interference suppression resistor
14 Axis of central electrode
15 Axis of spark plug
16 Contact
17 Connection
18 Housing step, sealing face towards engine
19 Combustion chamber
20 Step
21 Thread
A Distance between axes
B Region between front clamping shoulder and the sealing face towards the engine
D_{K} Outer diameter of ceramic body in front region 11
D_{I} Outer diameter of insulation body

1. Spark plug, the basic design of which is intended for internal combustion engines, comprising a metallic housing with an earth electrode arranged at the front and a thread with a rear sealing face for installation in the internal combustion engine, a pressure sensor arranged laterally in the housing for determining a combustion chamber pressure, a ceramic body with a central electrode, which ceramic body is arranged next to the pressure sensor in the housing and acts as an electrical insulator, wherein the ceramic body, as viewed from the combustion chamber, has front clamping shoulders and a rear stop for clamping the ceramic body in the housing, wherein the outer diameter of the ceramic body gradually decreases in the region of the thread which lies between the rear sealing face and the front clamping shoulder.

2. Spark plug according to claim 1, wherein the reduction has a conical or parabolic shape.

3. Spark plug according to claim 1, wherein the basic design can be fitted with an insulation sleeve with a selectable outer diameter D_{I}.

4. Spark plug according to claim 1, wherein the insulation body is attached replaceably in the housing.

5. Spark plug according to claim 1, wherein the axis of the central electrode is no more than 1 mm from the axis of the spark plug.

6. Spark plug according to claim 1, wherein the pressure sensor is based on the piezoelectric or optical principle.

7. Spark plug according to claim 1, wherein the pressure sensor is attached frontally on the combustion chamber side of the housing.

8. Spark plug according to claim 1, wherein the housing comprises a sensor connector.

9. Spark plug according to claim 8, comprising a contact between the pressure sensor and the sensor connector, wherein the contact is connected eccentrically to the sensor connector.

10. Spark plug according to claim 1, wherein the ceramic body projects out of the housing at the rear.

11. Spark plug according to claim 1, wherein the ceramic body comprises an inner cutout for an interference suppression resistor.

12. Spark plug according to claim 1, wherein the thread is smaller or equal to an M14 thread.

13. Spark plug according to claim 1, wherein at least 50% of the region between the clamping shoulder and the rear stop itself defines the gradually decreasing outer diameter of the ceramic body.

14. Spark plug according to claim 1, wherein at least 70% of the region between the clamping shoulder and the rear stop itself defines the gradually decreasing outer diameter of the ceramic body.

15. Spark plug according to claim 1, wherein at least 90% of the region between the clamping shoulder and the rear stop itself defines the gradually decreasing outer diameter of the ceramic body.
